(19) United States
(12) Patent Application Publication
(10) Pub. No.: US 2005/0169223 A1
(43) Pub. Date: Aug. 4, 2005

(54) Method and apparatus for facilitating a PTT session initiation using an IP-based protocol

(76) Inventors: Ronald T. Crocker, St. Charles, IL (US); Thomas B. Hart, West Dundee, IL (US); Robert Horvath, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 10/759,440

(22) Filed: Jan. 16, 2004

(51) Int. Cl. H04B 7/216

(52) U.S. Cl. 370/342

(57) ABSTRACT

Various embodiments are described to address the need for providing substantially reduced PTT call setup times and more efficient wireless bandwidth utilization for PTT sessions utilizing an IP-based protocol. The use of non-IP messaging between an originating MS (101) and PCF (131) and a target MS (102) and PCF (132), the use of IP-based messaging between the PCFs, the use of access channel signaling by the originating MS, and the generation of SIP responses by a target PCF on behalf of the target MS are described. Embodiments incorporating some or all of these protocol changes, can provide either, or both, reduced end-to-end call setup time for PTT as it presently exists in IS-2000 systems or reduced bandwidth consumption.

### REFERENCE(S) TO RELATED APPLICATION(S)

This application is related to a co-pending application entitled “METHOD AND APPARATUS FOR FACILITATING WIRELESS PRESENCE-BASED SERVICES,” filed on even date herewith, assigned to the assignee of the present application, and hereby incorporated by reference.

This application is related to a co-pending application Ser. No. 10/060,622, entitled “SESSION INITIATION PROTOCOL COMPRESSION,” filed Jan. 30, 2002, which is assigned to the assignee of the present application.

This application is related to a provisional application Ser. No. 60/486,684, entitled “WIRELESS COMMUNICATIONS NETWORK AND METHOD FOR ENABLING WIRELESS PRESENCE-BASED SERVICES,” filed Jul. 11, 2003.

This application is related to a provisional application Ser. No. 60/527,603, entitled “METHOD AND APPARATUS REDUCING PTT CALL SETUP DELAYS,” filed Dec. 5, 2003.

### FIELD OF THE INVENTION

The present invention relates generally to mobile communication systems and, in particular, to PTT session initiation using an IP-based protocol.

### BACKGROUND OF THE INVENTION

In general, Internet Protocol (IP)-based protocols and processes are today being incorporated into telecommunications systems to provide a variety of internet-based services. Specifically, IP-based protocols such as the Session Initiation Protocol (SIP) are being selected and adapted for these systems. The Internet Engineering Task Force (IETF) may be contacted for a complete description of the SIP standard and specification.

Generally SIP is a text-based protocol, similar to HTTP and SMTP, for initiating interactive communication sessions between users. Examples of possible session types include voice, instant messaging (IM), video, interactive games, and virtual reality. To incorporate SIP into wireless communication systems, however, bandwidth limitations such as those characteristic of wireless interfaces must be addressed. IP-based protocols like SIP tend to be “chatty” or overly verbose, requiring much more bandwidth than can be afforded in the spectrum-scarce world of wireless communications.

The use of IP-based protocols like SIP to support push-to-talk (PTT) calls in Code Division Multiple Access (CDMA) systems is also problematic. Such PTT services may have call setup times of around 10-15 seconds. Many users are likely find such wait times for a service like PTT unacceptable. Accordingly, it would be highly desirable to have a method and apparatus that could provide substantially reduced PTT call setup times and more efficient bandwidth utilization for PTT sessions utilizing an IP-based protocol.

### BRIEF DESCRIPTION OF THE DRAWINGS

FIG. 1 is a block diagram depiction of a mobile communication system in accordance with multiple embodiments of the present invention.

FIGS. 2a-2f, considered together (hereinafter “FIG. 2”), form a messaging flow diagram depicting session initiation messaging for a PTT request in accordance with multiple embodiments of the present invention.

FIGS. 3a-3c, considered together (hereinafter “FIG. 3”), form a messaging flow diagram depicting session initiation messaging for a PTT request for a scenario in which a target unit is not available, in accordance with multiple embodiments of the present invention.

### DETAILED DESCRIPTION OF EMBODIMENTS

Various embodiments are described to address the need for providing substantially reduced PTT call setup times and more efficient wireless bandwidth utilization for PTT sessions utilizing an IP-based protocol. The use of non-IP messaging between an originating MS and PCF and a target MS and PCF, the use of IP-based messaging between the PCFs, the use of access channel signaling by the originating MS, and the generation of SIP responses by a target PCF on behalf of the target MS are described. Embodiments incorporating some or all of these protocol changes, can provide either, or both, reduced end-to-end call setup time for PTT as it presently exists in IS-2000 systems or reduced bandwidth consumption.

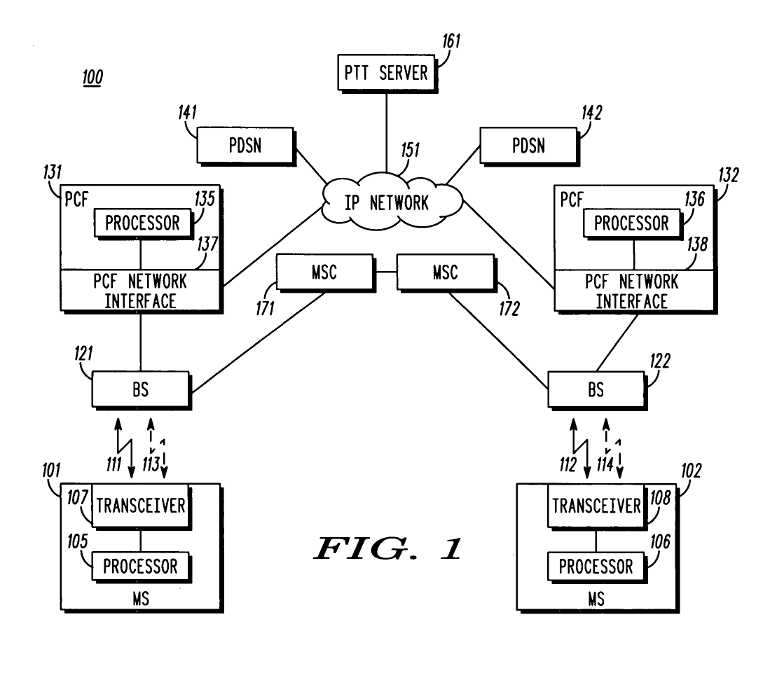

The disclosed embodiments can be more fully understood with reference to FIGS. 1-3. FIG. 1 is a block diagram depiction of a mobile communication system 100 in accordance with multiple embodiments of the present invention. Communication system 100 is a well-known Code Division Multiple Access (CDMA) system, specifically a cdma2000 system, which is based on the Telecommunications Industry Association/Electronic Industries Association (TIA/EIA) standards IS-2000 and IS-2001, suitably modified to implement the present invention. Alternative embodiments of the present invention may be implemented in communication systems that employ other technologies sufficiently similar to IS-2000 and IS-2001.

Those skilled in the art will recognize that FIG. 1 does not depict all of the network equipment necessary for system 100 to operate but only those system components and logical entities particularly relevant to the description of embodiments of the present invention. In particular, the network equipment of system 100 comprises components such as base stations (BSs) 121 and 122, mobile switching centers (MSCs) 171 and 172, packet control functions (PCFs) 131 and 132, packet data serving nodes (PDSNs) 141 and 142, internet protocol (IP) network 151, and PTT server 161. Generally, BSs, MSCs, PCFs, PDSNs, IP networks, and PTT servers are known in the art. For example, BSs are well-known to comprise components such as base station controllers (BSCs) and base transceiver systems (BTSs), neither of which are specifically shown in FIG. 1. Also, PCFs are well-known to comprise components such as processors and PCF network interfaces.

PCFs 131 and 132 are depicted in FIG. 1 as respectively comprising processors 135 and 136 and PCF network interfaces 137 and 138. In general, components such as PCF processors and PCF network interfaces are well-known. For example, PCF processors are known to comprise basic components such as, but not limited to, microprocessors, microcontrollers, memory devices, and/or logic circuitry. Such PCF components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement a PCF that performs the given logic. Therefore, PCFs 135 and 136 represent known PCFs that have been adapted, in accordance with the description herein, to implement multiple embodiments of the present invention.

BSs 121 and 122 use air interfaces comprising channels 111-114 for communication with remote units 101 and 102. IS-2000 terminology refers to remote units as mobile stations (MSs); however, remote units are not necessarily mobile or able to move. Thus, remote unit/MS platforms are known in the art to include devices such as mobile phones, computers, personal digital assistants, gaming devices, etc. In particular, MSs 101 and 102 each respectively comprise processors 105 and 106, transceivers 107 and 108, keypads (not shown), speakers (not shown), microphones (not shown), and displays (not shown). Processors, transceivers, keypads, speakers, microphones, and displays as used in MSs are all well-known in the art.

For example, MS processors are known to comprise basic components such as, but not limited to, microprocessors, digital signal processors (DSPs), microcontrollers, memory devices, and/or logic circuitry. Such MS components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement an MS that performs the given logic. Thus, MSs 101 and 102 represent known MSs that have been adapted, in accordance with the description herein, to implement embodiments of the present invention.

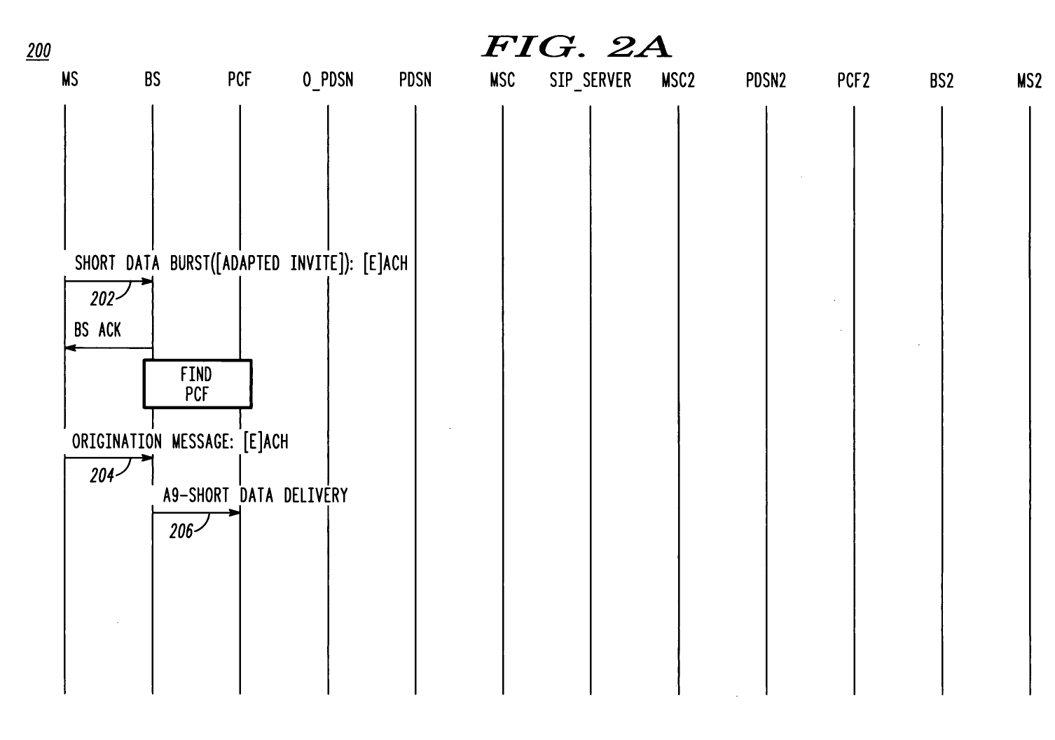

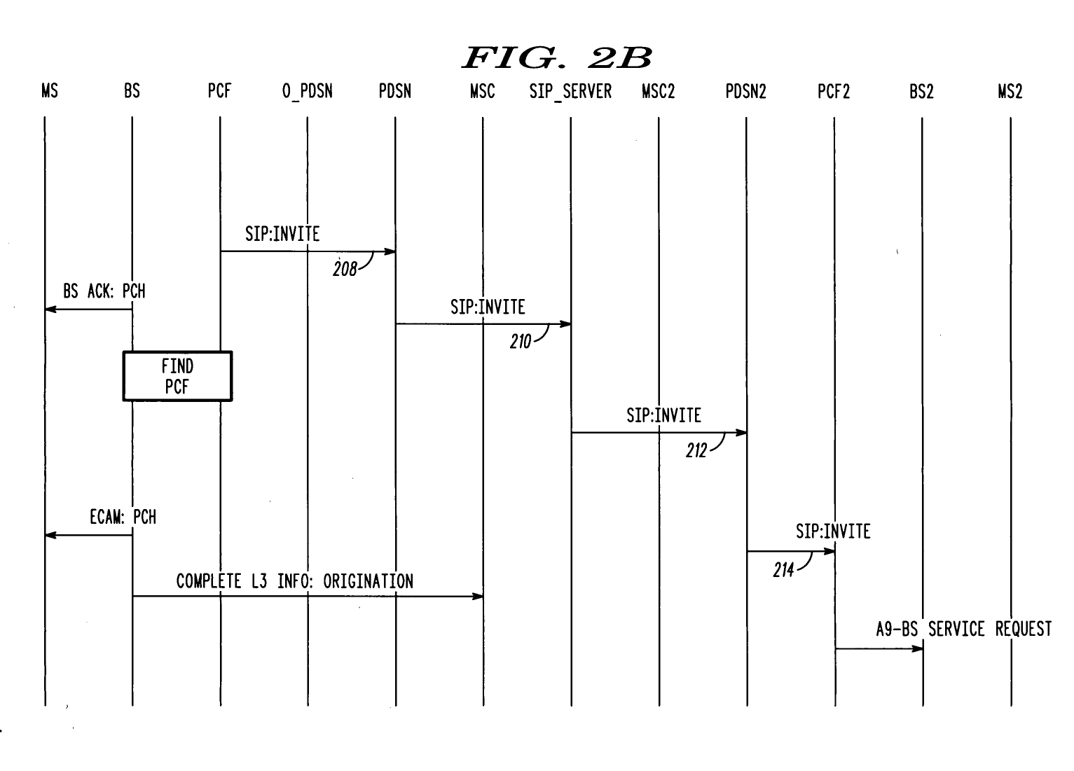

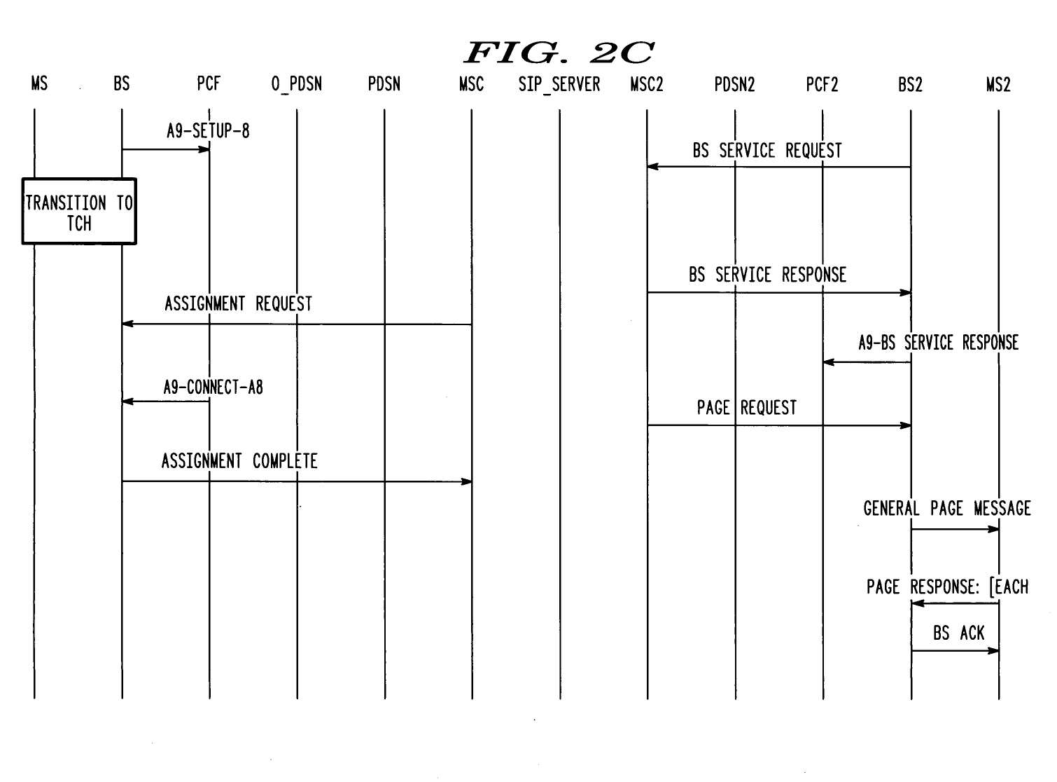

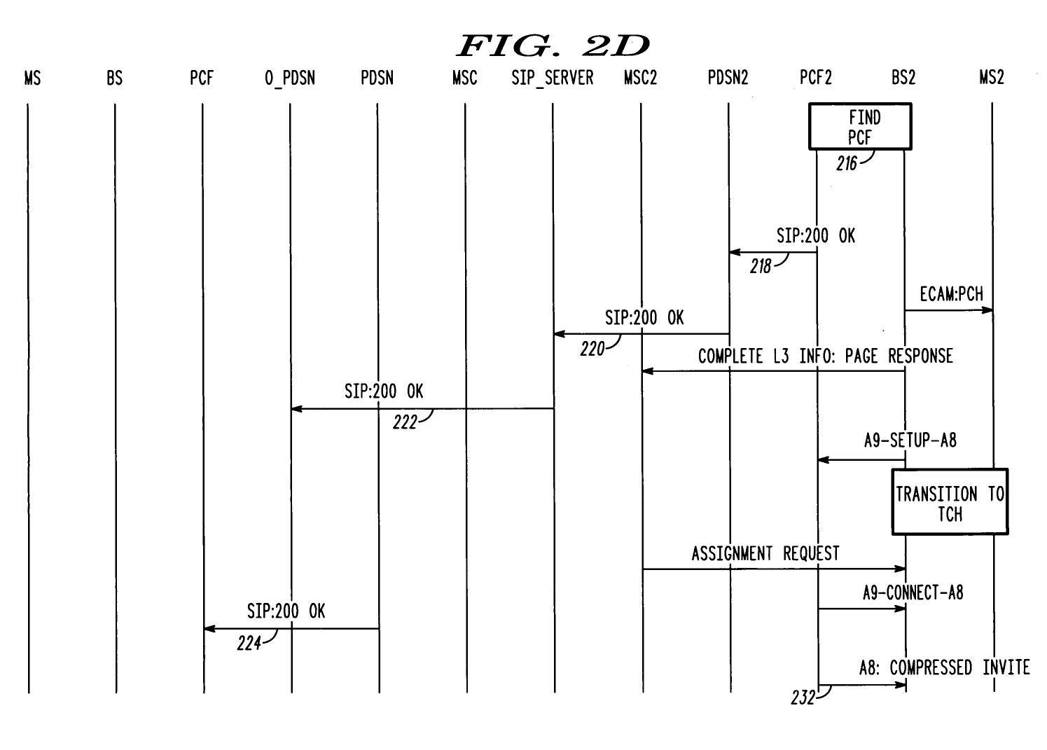

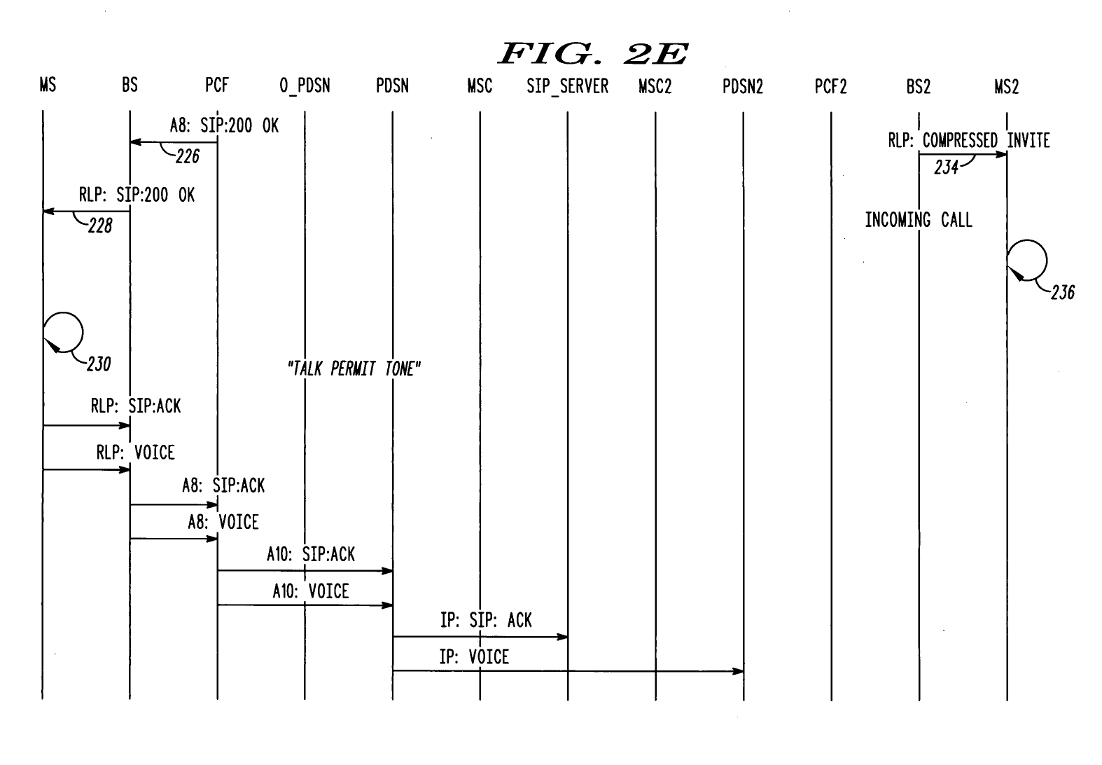

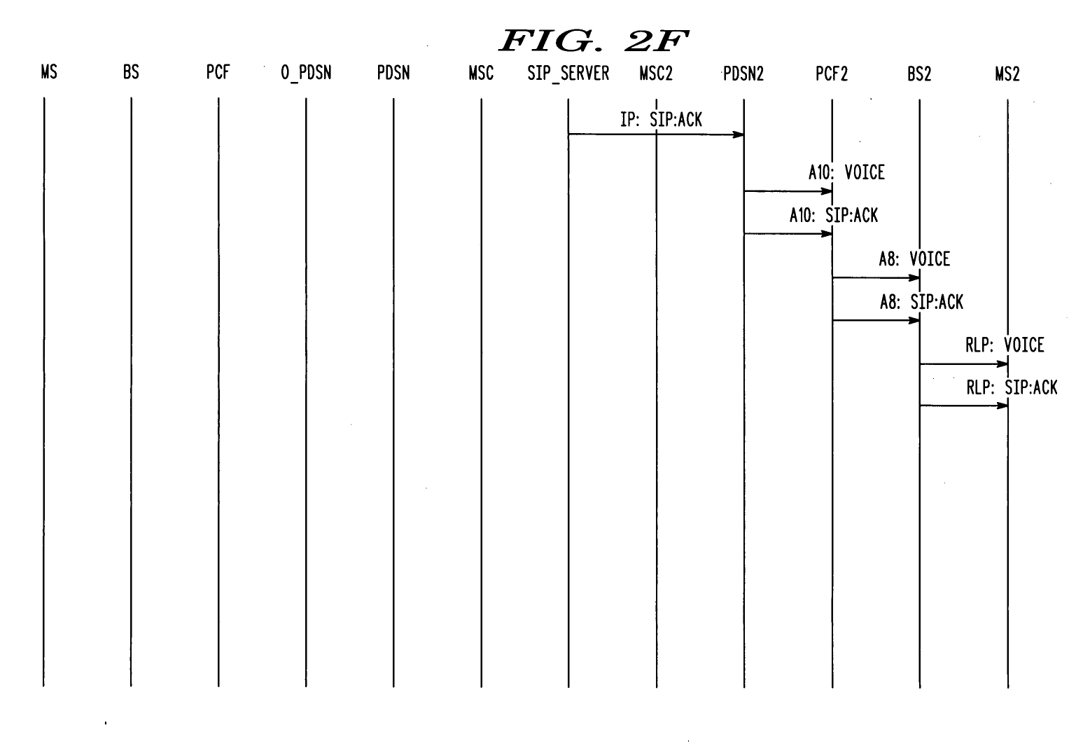

Operation of embodiments in accordance with the present invention occurs substantially as follows. FIG. 2 shows messaging flow diagram 200 depicting session initiation messaging for a PTT request in accordance with multiple embodiments of the present invention. When processor 105 of MS 101 detects a PTT session initiation indication, such as a PTT button being depressed by the MS user, processor 105 sends to BS 121 a session initiation request for the PTT session. The session initiation request is sent via transceiver 107 and a CDMA access channel, generically represented by air interface resource 111. IS-2000 channels 111 and 112 each comprises a variety of well-known non-traffic channel types, such as broadcast channels, paging channels, access channels (i.e., access channels (ACHs) and enhanced access channels (EACHs)), and common control channels. IS-2000 channels 113 and 114 each comprise dedicated traffic channels, which are dynamically assigned and de-assigned to support user services.

The session initiation request sent by MS 101 is in a format other than IP, although it may be in an IP-based format such as SIP, adaptations of SIP, or compressed forms of SIP. Also, although the embodiments described herein are primarily PTT call setup embodiments, the session initiation request may refer, in addition to a PTT call setup request, to requests such as a presence information update request or a voice over internet protocol (VoIP) call setup request. For example, in embodiments where SIP formatting is used, a PTT call setup request could take the form of a SIP INVITE message or a presence information update request could take the form of a SIP INVITE message, a SIP INFO message, or a SIP NOTIFY message.

As depicted in FIG. 2, messaging 202 represents the session initiation request sent by MS 101 to BS 121. Messaging 202 is sent via short data burst (SDB) messaging on an ACH or EACH. As mentioned above, a PTT call setup request could take the form of a SIP INVITE message. It could also take the form of a compressed SIP INVITE message. However, messaging 202 is an adapted invite message, which is neither a full SIP INVITE nor a compressed SIP INVITE. Rather it includes a subset of the information in a full SIP INVITE.

Adapted invite messaging 202 comprises a target identifier, an application identifier, originator vocoder information, and optionally an IP address corresponding to a PTT server 161. The target identifier may be the IP address of target MS 102, some other identifier that enables PCF 131 or PTT server 161 to determine the IP (or another) address of target MS 102, or an identifier of a dispatch group to which MS 102 belongs. The originator vocoder information includes information such as an indication of which vocoders are supported by MS 101 and/or an indication of which vocoders are preferred by MS 101. Lastly, the application identifier indicates what application MS 101 is requesting. Examples include a dispatch application, a presence application, or a voice over internet protocol (VoIP) application.

In the embodiments depicted by FIG. 2, processor 105 of MS 101 also sends a channel assignment request for the PTT session via transceiver 107 and a CDMA access channel, generically represented by air interface resource 111. Messaging 204 represents the channel assignment request sent to BS 121. It is an IS-2000 Origination message.

In an alternative embodiment, the session initiation request may be included within messaging for the channel assignment request. For example, the channel assignment request may take the form of an IS-2000 Reconnect message or an IS-2000 Origination message that has been extended to include a data burst message (DBM) portion. The session initiation request may then be included within this DBM portion.

PCF processor 135 receives session initiation request information from MS 101 via BS 121 and PCF network interface 137. In the embodiments depicted by FIG. 2, messaging 206 represents the session initiation request information, which takes the form of an adapted invite, i.e., in a non-IP format. Also, messaging 206 is received from BS 121 via A9-Short Data Delivery messaging.

Although MS 101's IP data session has been dormant, PCF processor 135 has been maintaining session information for MS 101's session. For example, session information such as an IP address corresponding to MS 101 and an IP address corresponding to PTT server 161 are maintained. Using this maintained session information and the received session initiation request, PCF processor 135 generates an IP-based message such as a Point-to-Point Protocol (PPP) frame containing an IP-packet. Since messaging 206 is in a non-IP format, the generation of an IP-packet and/or PPP frame involves determining and filling in the requisite header information.

Furthermore, for adapted invite embodiments, PCF processor 135 also generates a full SIP INVITE message from the adapted invite information received. Processor 135 then sends the generated message to PTT server 161 via PCF network interface 137. Thus, IP-based messaging 208 and 210, convey SIP INVITEs to PTT server 161 via PDSN 141. In alternative embodiments, such as those in which compressed invites are received by the PCF, the PCF may or may not decompress the invites when generating the IP-based packets.

PTT server 161 then receives and processes messaging 210 and relays the SIP INVITE for MS 102 to PCF 132 via PDSN 142 and messaging 212 and 214. PCF processor 136 receives the session initiation request messaging for MS 102 via PCF network interface 138. As discussed above with respect to the session initiation request sent by MS 101, the session initiation request messaging, in alternative embodiments, may refer to requests such as a presence information update request or a VoIP call setup request. And generally, the session initiation request messaging includes information such as a target identifier, an application identifier, and/or originator vocoder information.

In response to the session initiation request messaging, PCF processor 136, via PCF network interface 138, requests that MS 102 be paged. In the embodiments depicted by FIG. 2, a packet data service is requested for MS 102 causing MS 102 to be paged with a service option of “33”. When MS 102 responds to the page, PCF processor 136 will receive an indication of the response via PCF network interface 138. This indication may take various forms including a page response indication, a query for PCF information, which implies that the target unit responded to a page, or a request to connect the PCF to the BS (such as an A9-Connect-A8 message, for example), which also implies that the target unit responded to a page. Find PCF messaging 216 represents a query for PCF information by BS 122.

Similar to PCF 131, PCF processor 136 maintains session information for MS 102's dormant IP data session. It maintains session information such as an IP address corresponding to MS 102 and an IP address corresponding to PTT server 161. In response to the indication that MS 102 responded, PCF processor 136 generates response messaging using information from the maintained session information and the received session initiation request messaging. Examples of such response messaging include a SIP 100 Trying message, a SIP 200 OK message, a SIP INFO message, and a SIP NOTIFY message.

In the embodiments depicted by FIG. 2, using information it maintains and information from request messaging it receives, PCF processor 136 generates a SIP 200 OK message for MS 101, encapsulates it in an IP packet and PPP frame and sends it to PTT server 161 via PCF network interface 138. SIP 200 OK messaging 218 and 220 depict this conveyance via PDSN 142. Thus, a response is generated on behalf of MS 102 by PCF 132 without having to wait for MS 102 to acquire a traffic channel (TCH), for MS 102 to receive the SIP INVITE, or for MS 102 to transmit a SIP 200 OK in response. In addition, wireless bandwidth may be conserved by PCF 132 generating the response.

After sending the response messaging to PTT server 161, PCF processor 136 generates messaging to convey information from the session initiation request messaging to MS 102. In the embodiments depicted by FIG. 2, PCF 132 sends compressed invite messaging 232 to BS 122 via A8 messaging, which in turn is sent to MS 102 via radio link protocol (RLP) messaging 234. Receiving the compressed invite information (or, alternatively, a SIP INVITE or an adapted invite), MS 102 is able to indicate call information 236 for the incoming call to its user.

The SIP 200 OK message for MS 101 generated by PCF 132 is relayed by PTT server 161 via messaging 222 and 224 and PDSN 141 to PCF 131. Via PCF network interface 138, processor 135 receives messaging 224 in response to IP-based messaging 208 that it sent previously. In the embodiments depicted by FIG. 2, PCF 131 then sends the SIP 200 OK to BS 121 via A8 messaging 226, which in turn is sent to MS 101 via RLP messaging 228. Messaging 224, received from PCF 132 via PTT server 161 and PDSN 141, comprises an IP packet. However, messaging 226 sent to BS 121 is in a non-IP format such as adapted SIP messaging. Thus, PCF 135 receives the SIP 200 OK in an IP-format but converts it to a non-IP format before sending it on to BS 121 and MS 101. By so doing, the necessary SIP information can be conveyed over the wireless interface in a form that conserves bandwidth, rather than the verbose SIP and IP formats.

MS processor 105 receives messaging 228, in a non-IP format via transceiver 107, in response to its session initiation request (messaging 202). As depicted in FIG. 2, MS 101 receives messaging 228 via TCH 113, assigned in response to MS 101's earlier channel assignment request (messaging 204). However, MS 101 may alternatively receive messaging 228 via a CDMA common channel (generically represented by air interface resource 111) such as a CDMA Forward Paging Channel (F-PCH) or a CDMA Forward Common Control Channel (F-CCCH). Having received messaging 228, MS 101 is able to provide an indication 230 to its user that user voice activity for the PTT call may begin. Indication 230 may take the form of a “talk permit tone” played for the user. Thus, as depicted in FIG. 2, an active packet data session used to convey PTT voice information is established over TCH 113. By incorporating some or all of the protocol changes of the embodiments described above in an existing communication system, benefits such as reduced end-to-end call setup time and/or conserved wireless bandwidth may be realized.

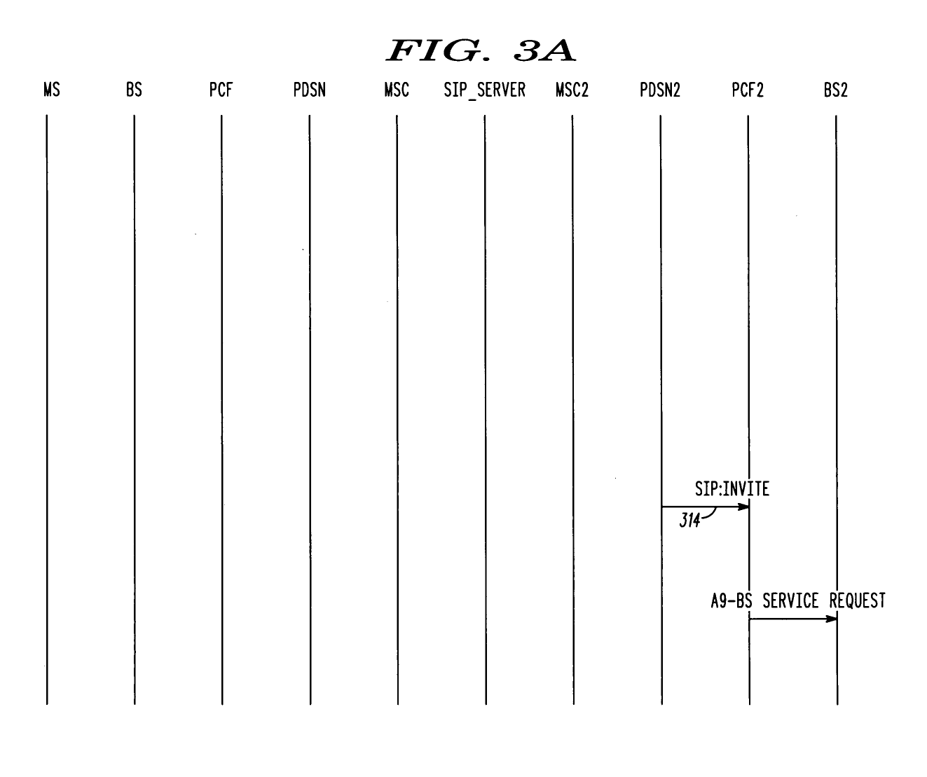

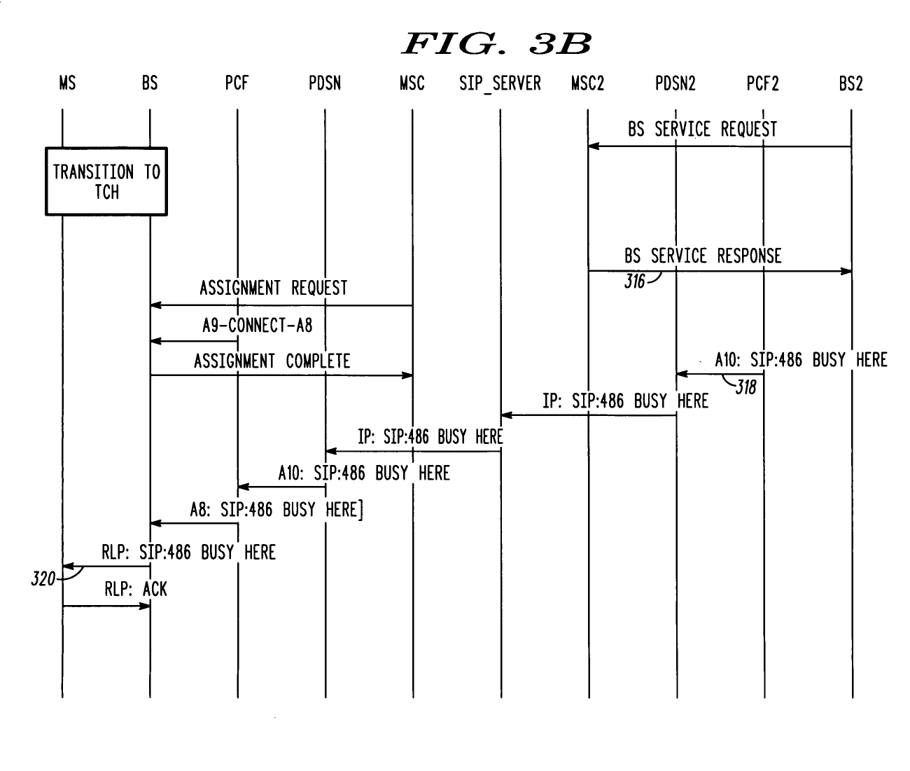

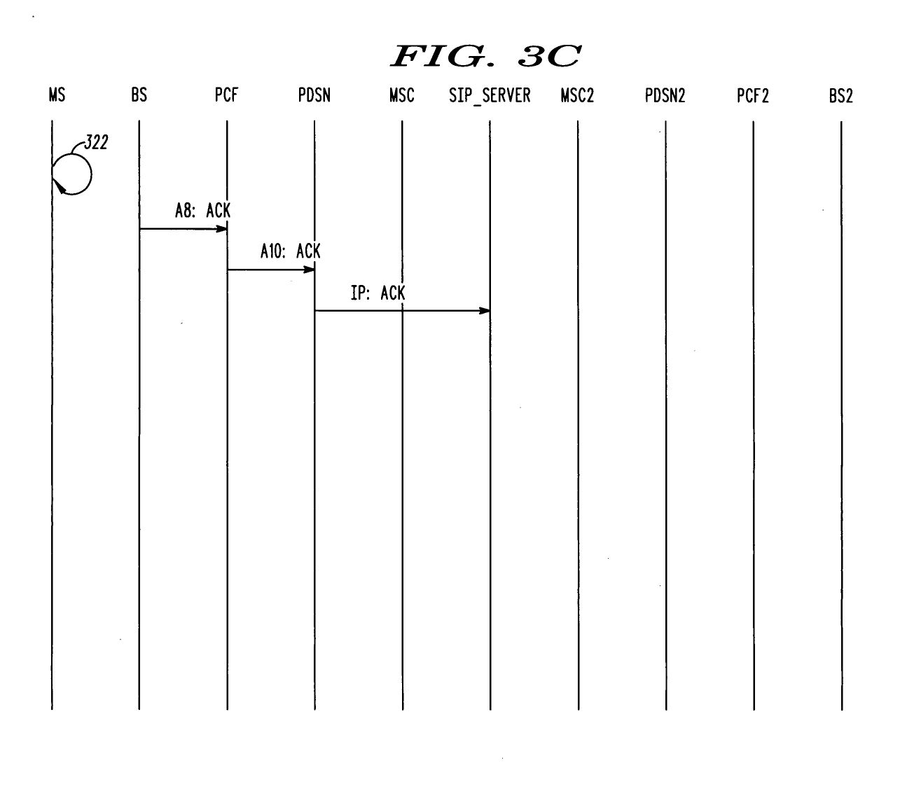

In the scenario described above with respect to FIG. 2, MS 102 was available and responded when paged for the packet data service. In contrast, FIG. 3 is a messaging flow diagram depicting session initiation messaging for a scenario in which a target unit is not available. FIG. 3 illustrates the relevant portion of the messaging flow that differs from the messaging flow of FIG. 2. In response to the session initiation request messaging (messaging 314), PCF processor 136, via PCF network interface 138, requests that MS 102 be paged. In response, however, PCF 132 receives an indication that the MS 102 is not available. As depicted in FIG. 3, this indication may comprise an A9-BS Service Response message (messaging 316). In the case where MS 102 is unavailable because it is busy, the BS Service Response message will have a cause field with a value of 0×08, indicating “MS busy”.

In response to the indication that MS 102 is not available, PCF processor 136 generates target-not-available messaging using information from the maintained session information and the received session initiation request messaging. A SIP 486 Busy Here message is one example of such target-not-available messaging; other examples include SIP INFO and SIP NOTIFY messages. As depicted in FIG. 3, PCF 132 generates a SIP 486 Busy Here message for MS 101, encapsulates it in an IP packet and PPP frame and sends it (messaging 318) to PTT server 161. The indication of MS 102's unavailability is eventually conveyed to MS 101 via PCF 131. Upon receiving this unavailability messaging (messaging 320) in response to the session initiation request, MS 101 can indicate (322) to its user that the PTT target unit is not available.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

1. A method for facilitating a push-to-talk (PTT) session initiation using an Internet Protocol (IP)-based protocol, the method comprising:
detecting, by an originator unit, a session initiation indication;
sending, by the originator unit in a non-IP format, a session initiation request for the PTT session, to a base station (BS) via a CDMA access channel;
sending, by the originator unit to the BS, a channel assignment request for the PTT session via a CDMA access channel; and
receiving, by the originator unit, messaging in response to the session initiation request.

2. The method of claim 1, wherein the IP-based protocol comprises Session Initiation Protocol (SIP).

3. The method of claim 1, wherein the session initiation request is sent via a short data burst (SDB).

4. The method of claim 1, wherein the session initiation request comprises information from the group consisting of a target identifier, an application identifier, a PTT server address, and originator vocoder information.

5. The method of claim 4, wherein the originator vocoder information comprises information from the group consisting of an indication of supported vocoders and an indication of preferred vocoders.

6. The method of claim 4, wherein the application identifier identifies an application from the group consisting of dispatch, presence, and voice over internet protocol (VoIP).

7. The method of claim 1, wherein the session initiation request comprises a request from the group consisting of a PTT call setup request, a presence information update request, and a VoIP call setup request.

8. The method of claim 7, wherein the PTT call setup request comprises a SIP INVITE message.

9. The method of claim 7, wherein the presence information update request comprises a message from the group consisting of a SIP INVITE message, a SIP INFO message, and a SIP NOTIFY message.

10. The method of claim 1, wherein the session initiation request is included within messaging for the channel assignment request.

11. The method of claim 10, wherein the messaging for the channel assignment request comprises an IS-2000 Reconnect message.

12. The method of claim 1, wherein the channel assignment request comprises an IS-2000 Origination message.

13. The method of claim 1, wherein the messaging in response to the session initiation request is received via a traffic channel assigned in response to the channel assignment request.

14. The method of claim 1, wherein the messaging in response to the session initiation request is received via a CDMA common channel from the group consisting of a CDMA Forward Paging Channel (F-PCH) and a CDMA Forward Common Control Channel (F-CCCH).

15. The method of claim 1, further comprising indicating, upon receiving the messaging in response to the session initiation request, that user voice activity for the PTT call may begin.

16. The method of claim 1, further comprising indicating, upon receiving the messaging in response to the session initiation request, that a PTT target unit is not available.

17. The method of claim 1, further comprising sending and receiving, by the originator unit in an active packet data session, PTT voice information via a traffic channel assigned in response to the channel assignment request.

18. A method for facilitating a push-to-talk (PTT) session initiation using an Internet Protocol (IP)-based protocol, the method comprising:
maintaining, by a packet control function (PCF), session information relating to a dormant IP data session of an originator unit;
receiving, by the PCF from the originator unit via a base station (BS), a session initiation request in a non-IP format for the PTT session;
generating, by the PCF, an IP-based message using the session information and the session initiation request in a non-IP format; and
sending, by the PCF, the IP-based message to a PTT server.

19. The method of claim 18, wherein the session information comprises information from the group consisting of an IP address corresponding to the originator unit and an IP address corresponding to the PTT server.

20. The method of claim 18, wherein the session initiation request in a non-IP format comprises information from the group consisting of a target identifier, an application identifier, and originator vocoder information.

21. The method of claim 18, wherein the session initiation request in a non-IP format comprises a request from the group consisting of a PTT call setup request, a presence information update request, and a VoIP call setup request.

22. The method of claim 21, wherein the PTT call setup request comprises a SIP INVITE message and wherein the presence information update request comprises a message from the group consisting of a SIP INVITE message, a SIP INFO message, and a SIP NOTIFY message.

23. The method of 18, wherein the session initiation request is received from the BS via A9-Short Data Delivery messaging.

24. The method of 18, wherein the IP-based message comprises an IP packet.

25. The method of 24, wherein the IP-based message comprises an IP packet contained within a Point-to-Point Protocol (PPP) frame.

26. The method of 18, further comprising:
receiving, by the PCF, information in response to the IP-based messaging; and
sending, by the PCF, the information as response messaging to the originator unit via the BS.

27. The method of 26, wherein the response messaging is sent to the BS via A8 messaging.

28. The method of 26, wherein the information comprises an IP packet and the response messaging is in a non-IP format.

29. A method for facilitating a push-to-talk (PTT) session initiation using an Internet Protocol (IP)-based protocol, the method comprising:
maintaining, by a packet control function (PCF), session information relating to a dormant IP data session of a target unit;
receiving, by the PCF from a PTT server, session initiation request messaging for the target unit for the PTT session;
requesting, by the PCF in response to the session initiation request messaging, that the target unit be paged;
receiving, by the PCF from a base station (BS), an indication that the target unit responded to a page;
generating, by the PCF in response to the indication that the target unit responded to the page, response messaging using information from the session information and the session initiation request messaging; and
sending, by the PCF, the response messaging to the PTT server.

30. The method of claim 29, wherein the session information comprises information from the group consisting of an IP address corresponding to the target unit and an IP address corresponding to the PTT server.

31. The method of 29, wherein the page is for a packet data service.

32. The method of claim 31, wherein the page has a service option of “33”.

33. The method of 29, wherein the indication that the target unit responded to the page comprises an indication from the group consisting of a page response indication, a query for PCF information that implies that the target unit responded to a page, and a request to connect the PCF to the BS that implies that the target unit responded to a page.

34. The method of claim 33, wherein the request to connect the PCF to the BS is an A9-Connect-A8 message.

35. The method of 29, wherein the response messaging comprises an IP packet.

36. The method of 35, wherein the response messaging comprises a Point-to-Point Protocol (PPP) frame encapsulating the IP packet.

37. The method of 35, wherein the response messaging comprises a SIP message from the group consisting of a SIP 100 Trying message, a SIP 200 OK message, a SIP INFO message, and a SIP NOTIFY message.

38. The method of 29, further comprising:
after sending the response messaging to the PTT server, sending, by the PCF, information from the session initiation request messaging to the target unit via the BS.

39. The method of 38, wherein the information from the session initiation request messaging is sent to the BS via A8 messaging.

40. The method of claim 29, wherein the session initiation request messaging comprises information from the group consisting of an IP address of the PTT server, an IP address of the target unit, and an application identifier.

41. The method of claim 40, wherein the application identifier identifies an application from the group consisting of dispatch, presence, and Voice over Internet Protocol (VoIP) applications.

42. The method of claim 29, wherein the session initiation request messaging comprises information from the group consisting of a target identifier, an application identifier, and originator vocoder information.

43. The method of claim 29, wherein the session initiation request messaging comprises a request from the group consisting of a PTT call setup request, a presence information update request, and a VoIP call setup request.

44. The method of claim 43, wherein the PTT call setup request comprises a SIP INVITE message and wherein the presence information update request comprises a message from the group consisting of a SIP INVITE message, a SIP INFO message, and a SIP NOTIFY message.

45. A method for facilitating a push-to-talk (PTT) session initiation using an Internet Protocol (IP)-based protocol, the method comprising:
maintaining, by a packet control function (PCF), session information relating to a dormant IP data session of a target unit;
receiving, by the PCF from a PTT server, session initiation request messaging for the target unit for the PTT session;
requesting, by the PCF in response to the session initiation request messaging, that the target unit be paged;
receiving, by the PCF, an indication that the target unit is unavailable;
generating, by the PCF, responsive to the indication that the target unit is not available, target-not-available messaging using information from the session information and the session initiation request messaging; and
sending, by the PCF, the target-not-available messaging to the PTT server.

46. The method of claim 45, wherein the indication that the target unit is not available comprises an indication that the target unit is busy.

47. The method of claim 46, wherein the indication that the target unit is not available comprises a BS Service Response message with a cause field having a value that indicates “MS busy”.

48. The method of claim 45, wherein the target-not-available messaging comprises a message from the group consisting of a SIP 486 Busy Here message, a SIP INFO message, and a SIP Notify message.

49. A mobile station (MS) for facilitating a push-to-talk (PTT) session initiation using an Internet Protocol (IP)-based protocol, the MS comprising:
a transceiver; and
a processor, communicatively coupled to the transceiver,
adapted to detect a session initiation indication,
adapted to send, to a base station (BS) via the transceiver and a CDMA access channel, a session initiation request in a non-IP format for the PTT session,
adapted to send, to the BS via the transceiver and a CDMA access channel, a channel assignment request for the PTT session, and
adapted to receive, via the transceiver, messaging in response to the session initiation request in a non-IP format.

50. A packet control function (PCF) for facilitating a push-to-talk (PTT) session initiation using an Internet Protocol (IP)-based protocol, the PCF comprising:
a PCF network interface adapted to send and receive messaging using at least one communication protocol;
a processor, communicatively coupled to the PCF network interface,
adapted to maintain session information relating to a dormant IP data session of an originator unit,
adapted to receive, from the originator unit via a base station (BS) and the PCF network interface, a session initiation request in a non-IP format for the PTT session,
adapted to generate an IP-based message using the session information and the session initiation request in a non-IP format, and
adapted to send, via the PCF network interface, the IP-based message to a PTT server.

51. A packet control function (PCF) for facilitating a push-to-talk (PTT) session initiation using an Internet Protocol (IP)-based protocol, the PCF comprising:
a PCF network interface adapted to send and receive messaging using at least one communication protocol;
a processor, communicatively coupled to the PCF network interface,
adapted to maintain session information relating to a dormant IP data session of a target unit,
adapted to receive, from a PTT server via the PCF network interface, session initiation request messaging for the target unit for the PTT session,
adapted to request, via the PCF network interface in response to the session initiation request messaging, that the target unit be paged,
adapted to receive, from a base station (BS) via the PCF network interface, an indication that the target unit responded to a page,
adapted to generate, in response to the indication that the target unit responded to the page, response messaging using information from the session information and the session initiation request messaging, and
adapted to send, via the PCF network interface, the response messaging to the PTT server.

52. A packet control function (PCF) for facilitating a push-to-talk (PTT) session initiation using an Internet Protocol (IP)-based protocol, the PCF comprising:
a PCF network interface adapted to send and receive messaging using at least one communication protocol;
a processor, communicatively coupled to the PCF network interface,
adapted to maintain session information relating to a dormant IP data session of a target unit;
adapted to receive, from a PTT server via the PCF network interface, session initiation request messaging for the target unit for the PTT session;
adapted to request, via the PCF network in response to the session initiation request messaging, that the target unit be paged;
adapted to receive, via the PCF network, an indication that the target unit is unavailable;
adapted to generate, responsive to the indication that the target unit is not available, target-not-available messaging using information from the session information and the session initiation request messaging; and
adapted to send, via the PCF network, the target-not-available messaging to the PTT server.
